(19) United States
(12) Patent Application Publication
(10) Pub. No.: US 2010/0111441 A1
(43) Pub. Date: May 6, 2010

(54) METHODS, COMPONENTS, ARRANGEMENTS, AND COMPUTER PROGRAM PRODUCTS FOR HANDLING IMAGES

(75) Inventors: Yingen Xiong, Mountain View, CA (US); Xianglin Wang, Santa Clara, CA (US); Kari Pulli, Palo Alto, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION, Espoo (FI)

(21) Appl. No.: 12/263,364

(22) Filed: Oct. 31, 2008

(51) Int. Cl. G06K 9/40

(52) U.S. Cl. 382/275

(57) ABSTRACT

Artifacts are located in an electronic representation of an image. There is stored a characterisation of a located artifact. There is also output at least one of a characterisation of the artifact or a representation of the artifact. The system may aid the user to correct artifacts, for example by guiding her how to take a new image that contains data that helps in correcting the artifacts.

### TECHNICAL FIELD

Exemplary aspects of embodiments of the present invention are related to the technical field of digital photography, especially the field of enhancing the quality of digital photographs in an interactive way. Advantages of the invention may become particularly prominent in assembling a composite image or panoramic image from two or more component images.

### BACKGROUND

Digital photography in general refers to the technology of using an electronic image capturing device for converting a scene or a view of a target into an electronic representation of an image. Said electronic representation typically consists of a collection of pixel values stored in digital form on storage medium either as such or in some compressed form. At the time of writing this description a typical electronic image capturing device comprises an optical system designed to direct rays of electromagnetic radiation in or near the range of visible light onto a two-dimensional array of radiation-sensitive elements, as well as reading and storage electronics configured to read radiation-induced charge values from said elements and to store them in memory.

Panoramic image capturing refers to a practice in which two or more images are captured separately and combined so that the resulting panoramic image comprises pixel value information that originates from at least two separate exposures.

A human observer will conceive a displayed image as being of the higher quality the less it contains artifacts that deviate from what the human observer would consider a natural representation of the whole scene covered by the image.

### TERMS

The following terminology is used in this text.

Scene is an assembly of one or more physical objects, of which a user may want to produce one or more images.

Image is a two-dimensional distribution of electromagnetic radiation intensity at various wavelengths, typically representing a delimited view of a scene.

Electronic representation of an image is an essentially complete collection of electrically measurable and storable values that corresponds to and represents the two-dimensional distribution of intensity values at various wavelengths that constitutes an image.

Pixel value is an individual electrically measurable value that corresponds to and represents an intensity value of at least one wavelength at a particular point of an image.

Image data is any data that constitutes or supports an electronic representation of an image, or a part of it. Image data typically comprises pixel values, but it may also comprise metadata, which does not belong to the electronic representation of an image but complements it with additional information.

Artifact is a piece of image data that, when displayed as a part of an image, makes a human observer conceive the image as being of low quality. An artifact typically makes a part of the displayed image deviate from what the human observer would consider a natural representation of the corresponding scene.

Characterisation of an artifact is data in electronic form and contains information related to a particular artifact.

Representation of an artifact is user-conceivable information that is displayed or otherwise brought to the attention of a human user in order to tell the user about the artifact.

### SUMMARY

Exemplary embodiments of the invention, which may have the character of a method, device, component, module, system, service, arrangement, computer program, and/or computer program product, may provide an advantageous way of producing a panoramic image that a human observer could conceive as being of high quality. Advantages of such exemplary embodiments of the invention may involve ease of use, reduced need of storage capacity, a user's experience of good quality, and many others.

According to an embodiment of the invention there is provided an apparatus, comprising:

an artifact locating subsystem configured to locate an artifact in an electronic representation of an image,

an artifact evaluating subsystem configured to store a characterisation of a located artifact, and

an artifact data handling subsystem configured to output at least one of a characterisation of an artifact or a representation of a stored characterisation of an artifact.

According to another embodiment of the invention there is provided an apparatus, comprising:

an image data handling subsystem configured to store electronic representations of images,

an artifact data handling subsystem configured to handle characterisations of artifacts located in an image,

a displaying subsystem configured to display an image and representations of artifacts located in said image, and

a user input subsystem configured to receive user inputs concerning corrective action to be taken to correct artifacts, representations of which were displayed in said displaying subsystem.

According to another embodiment of the invention there is provided a method, comprising:

locating an artifact in an electronic representation of an image,

storing a characterisation of the located artifact, and

outputting at least one of a characterisation of the artifact or a representation of the artifact.

According to another embodiment of the invention there is provided a method, comprising:

storing an electronic representation of an image,

displaying the image and representations of artifacts located in said image, and

receiving user inputs concerning corrective action to be taken to correct artifacts, representations of which were displayed.

According to another embodiment of the invention there is provided a computer-readable storage medium having computer-executable components that, when executed on a processor, are configured to implement a process comprising:

locating an artifact in an electronic representation of an image,

storing a characterisation of the located artifact, and

outputting at least one of a characterisation of the artifact or a representation of the artifact.

According to another embodiment of the invention there is provided a computer-readable storage medium, having computer-executable components that, when executed on a processor, are configured to implement a process comprising:

storing an electronic representation of an image,

displaying the image and representations of artifacts located in said image, and

receiving user inputs concerning corrective action to be taken to correct artifacts, representations of which were displayed.

A number of advantageous embodiments of the invention are further described in the depending claims.

### BRIEF DESCRIPTION OF DRAWINGS

FIG. 1 illustrates taking component images of a scene.

FIG. 2 illustrates a panoramic image made of component images of FIG. 1.

FIG. 3 illustrates a method and a computer program product for image handling.

FIG. 4 illustrates a flow diagram of a method and a computer program product.

FIG. 5 illustrates a state diagram of a method and a computer program product.

FIG. 6 illustrates a user interface for image handling.

FIG. 7a illustrates a part of a user interface for image handling.

FIG. 7b illustrates a part of a user interface for image handling.

FIG. 7c illustrates a transition between states in a method and a computer program product.

FIG. 8 illustrates an apparatus for image handling.

FIG. 9 illustrates an apparatus for image handling.

FIG. 10 illustrates two apparatuses for image handling.

### DETAILED DESCRIPTION OF SOME ADVANTAGEOUS EMBODIMENTS OF THE INVENTION

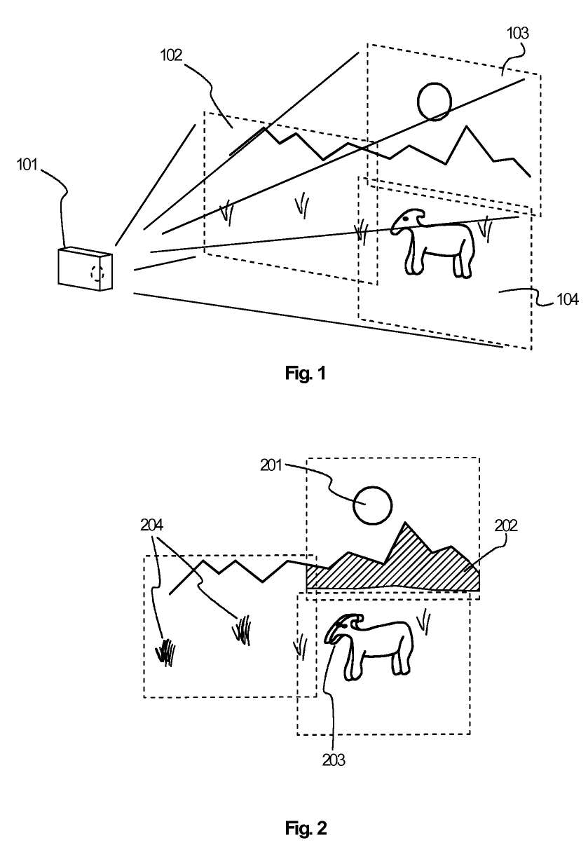

FIG. 1 illustrates schematically a situation in which an electronic image capturing device 101 is utilized to capture and create a panoramic image of a scene. Three separate images are taken, changing the aiming direction between images so that each image constitutes a different component image. The delimited parts of the scene that will appear in each component image are illustrated with the dashed boundaries 102, 103, and 104. The component images are made to partially overlap with each other in order to facilitate the production of a panoramic image. The extent of overlapping is intentionally made small in FIG. 1 for graphical clarity of the illustration; in practice the component images of which a panoramic image is to be produced should typically overlap more than in FIG. 1.

FIG. 2 illustrates schematically a panoramic image produced by aligning and combining the component images properly. Producing the panoramic image is often referred to as stitching. The panoramic image of FIG. 2 contains artifacts that would cause a human observer conceive it as being of low quality. Examples of such artifacts are a pixel-value-saturated area 201 (an image of the sun, where the pixel values are too bright), an area of suboptimal exposure 202 (an image of a part of the mountain range, where the pixel values are too dark), a motion blur 203 (an image of the animal head, which moved during the exposure time), and out-of-focus artifacts 204 (nearby vegetation in a component image that was focused to the faraway mountains). Examples of other kinds of artifacts that would cause a human observer conceive the panoramic image as being of low quality include but are not limited to the following:
ghosting (doubled appearance of objects that moved between the separate exposures)
missing content (the intended continuous panoramic view contains areas of which no image was taken),
shaky hand (like motion blur, but affects the whole area of a component image)
a person not looking at the camera or not having a desired expression or posture,
unwanted image content (for example, a passer-by on the background),
insufficient resolution concerning a whole image or a detail.

Examples of troublesome effects concerning the production of a panoramic image are such features in the component images that tend to make the borders of the component images pronouncedly visible in the panoramic image. For example, a significant difference between component images in the level of exposure of a field that should continue smoothly from one component image to another tends to cause an odd-looking colour change in the panoramic image. Optical aberration in the imaging optics may cause graphical distortion that increases towards the edges of each component image; if neighbouring component images do not overlap enough, it may prove to be difficult to find the correct way of aligning and stitching them together in the production of the panoramic image.

Artifacts that could appear in even a single image include, but are limited to, those of the above that are not associated with combining image data from different images.

Artifacts in an image, which cause a human observer to conceive it as being of low quality, may be such that the photographer may not notice them while he is still at the scene, although there are also artifacts that are easy to notice. Considering one of the artifacts illustrated in FIG. 2 as an example, if the photographer noticed immediately that the animal moved its head just when he was taking the component image illustrated as dashed boundary 104 in FIG. 1, he could have taken a new component image with essentially the same aiming direction when the animal again stood still. In the production of the panoramic image the whole component image in which the animal moves its head could have been completely replaced with the new component image, or that part of it where the motion-blurred animal appeared could have been replaced with a corresponding area taken from the new component image.

Similar considerations apply to the other artifacts. Although some of the artifacts may be correctable with later processing of the image data, some are such that a better starting point would be achieved, especially for producing a panoramic image which a human observer would conceive as being of high quality, by taking one or more additional component images. Noticing the artifacts immediately, and/or using human judgement about whether or not an artifact is susceptible to correction by post-processing, may be difficult if the user has only a limited-size display available in the equipment that he carries around for taking images.

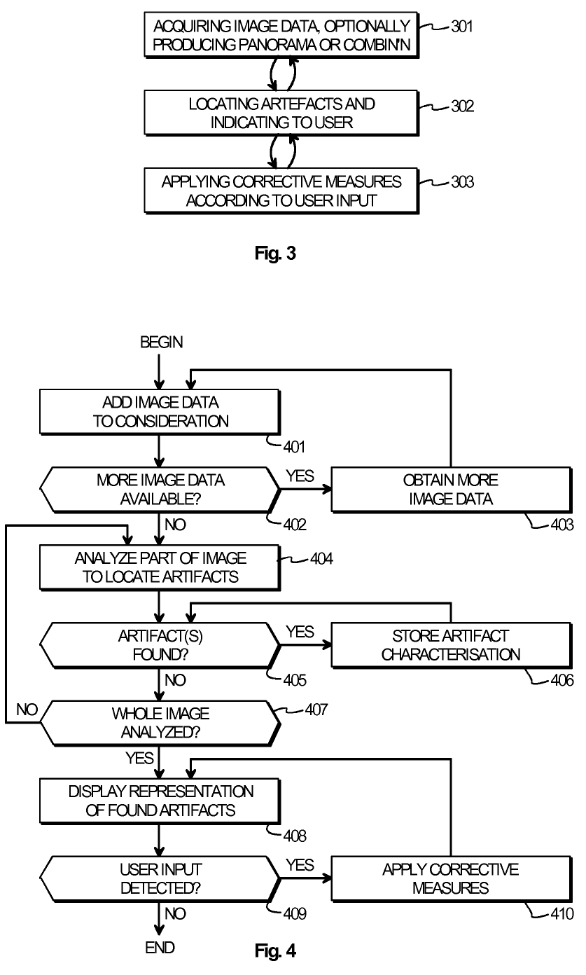

FIG. 3 illustrates an operating principle of a method and a computer program product. What is said in the following concerning a method, is applicable to the computer program product by interpreting that the software contained in the computer program product comprises machine-readable instructions which, when executed on a processor, make the processor implement the corresponding features of the method.

According to block 301, the method comprises acquiring image data. It may also comprise producing a panoramic image, or a combined image that includes image data from two or more component images. An example of the latter is a process of acquiring a first image and acquiring at least a second image and possibly a number of subsequent images, so that at least some of the acquired images have some overlapping areas that allow a stitching algorithm to recognize an appropriate way of stitching the images into a combined image. If the method is executed in an electronic image capturing device, acquiring an image typically means reading into run-time memory the digitally stored form of an image that the user of the device has taken. If the method is executed in a processing apparatus external to any electronic image capturing device, acquiring an image typically means receiving into run-time memory the digitally stored form of an image over a communications connection, or reading into run-time memory the digitally stored form of an image from a storage memory that can be internal, external and/or removable.

For producing a panoramic it is possible to apply a stitching algorithm to stitch acquired images into a larger, combined image. It should be noted that combining a number of component images is not limited to producing an image that covers a wider view than any of the component images alone. Combining images may also involve utilizing the redundant image data of the overlapping areas to selectively enhance resolution or other features of the resulting combined image.

We assume that—irrespective of whether a panoramic image was produced in block 302—the image contains some artifacts. According to block 302, artifacts are located and indicated to a user. Locating an artifact means identifying a number of pixels in the digitally stored form of an image that according to an evaluation criterion deviate from optimal image content. Examples of evaluation criteria include, but are not limited to, the following:
an array of adjacent pixels all have essentially the same value (indicates pixel value saturation or missing picture content),
in an array of adjacent pixels, a transition occurs from a first prevailing pixel value range to a second, different prevailing pixel value range, and said transition coincides with an edge of a component image (indicates suboptimal exposure),
a pattern of pixel values is repeated in essentially the same form at a transition distance (indicates ghosting),
a pattern of pixel values repeats continuously in some direction (indicates motion blur),
an array of pixel values does not contain any edges, i.e. any sharp transitions of pixel values, at all (indicates out-of-focus).

Of course these are just very simple examples and listed here mainly for illustration purpose. In practice, more complex and advanced mechanisms or methods are likely to be used. For example, a filter can be designed to address each specific artefact type (such as motion blur, defocus, insufficient or too large exposure, etc.). The filter operates on the image pixel values, and gives a positive feedback for each pixel or area if it contains the corresponding artefact. The filter can additionally tell the likelihood that an artefact occurs and how severe it is.

An addition or alternative to making the apparatus automatically locate artifacts is the possibility of receiving inputs from a user, explicitly marking a part of a displayed image as containing an artifact.

If the image is a panoramic image or other kind of combined image, a so-called registration between two component images has been performed, for example by calculating a homography transformation. Evaluation methods can be applied to find out, how good the transformation is. It is possible to compare pixel values, gradient values, image descriptors, SIFT (Scale Invariant Feature Transform) features, or the like. If the registered images do not agree well, within a given tolerance, this can be determined to be an artifact.

When an artifact has been located, it is advantageous to store a characterisation of the artifact. An example of a characterisation includes data about the location of the artifact in the image (which pixels are affected), the type of the artifact (which evaluation criterion caused the artifact to be located), and the severity of the artifact. The severity of the artifact can be analyzed and represented in various forms, like the size of the affected area in the image, the marginal by or the extent to which the evaluation criterion was fulfilled, the likelihood the artefact will appear in the image and others.

Further according to block 302, a representation of at least some of the located artifacts is brought to the attention of a user. We assume that a user interface exists, through which the user receives indications of how the image looked like and/or how the process of producing the panoramic image is proceeding. Most advantageously the user interface comprises a display configured to give alphanumeric and/or graphical indications to the user. Various advantageous ways of indicating located artifacts to a user are considered later.

In addition to displaying representations of the located artifacts to a user, the user interface is configured to receive inputs from the user, indicating what the user wants to do with the located and indicated artifacts. According to block 303, corrective measures are applied according to the inputs received from the user. In an exemplary case, at least one located and indicated artifact is of some nature that is susceptible to correction by processing the image data. In that case the indication to the user may include a prompt for the user to select, whether corrective processing should be applied. If the user gives a positive input, corrective processing (such as recalculating some of the pixel values with some kind of a filtering algorithm) is applied. In another exemplary case, artifact(s) contained in at least one image is of some nature that would be difficult to correct by just processing existing image data. In that case the indication to the user may include a prompt for the user to shoot at least a significant part of that component image again. If the user takes another component image, that image is taken as additional image data to the production of the panoramic image.

The back-and-forth arrows between blocks 301, 302, and 303 illustrate the fact that the invention does not require (but does not preclude either) executing corresponding method steps in any strictly defined temporal order. Locating artifacts according to block 302 may begin as soon as there is at least one image available, and may continue in parallel with the acquisition of further images according to block 301. Above we already indicated that one way of applying corrective measures according to block 303 can be prompting for and proceeding to acquiring more component images according to block 301. Some artifacts may have been corrected already according to block 303 while locating other artifacts is still running according to block 302. A large number of other examples can be presented, illustrating the not-any-particular-order character of the method.

FIG. 4 illustrates an operating principle of a method and a computer program product according to one embodiment of the invention, where proceeding through the phases illustrated as blocks 301, 302, and 303 takes place in a relatively straightforward manner. At step 401 a certain amount of image data, for example the image data contained in one component image, is added to the panoramic image that will be produced. The loop that consists of checking for more available image data in step 402, obtaining the available additional image data in step 403, and returning to step 401 is repeated until the check made in step 402 gives a negative result. As an example, we may assume that an electronic image acquisition device is operating in panoramic imaging mode, and the loop consisting of steps 401, 402, and 403 is repeated until the user stops making further exposures for the panoramic image. Utilizing a stitching algorithm to properly add together the image data of all component images constitutes a part of step 401. If only a single image is considered, execution proceeds directly through steps 401 and 402 to step 404.

Step 404 illustrates examining the (panoramic or single) image for artifacts. If the evaluation-criteria-based approach explained above is used, step 404 may involve going through a large number of stored pixel values that represent the image, and examining said stored pixel values part by part in order to notice, whether some part(s) of the image fulfil one or more of the criteria. If artifacts are found according to step 405, their characterisations are stored according to step 406. A return from the check of step 407 back to analyzing the image occurs until the whole image has been thoroughly analyzed.

Step 408 illustrates displaying a representation of the found artifacts to the user, preferably together with some prompt(s) or action alternative(s) for the user to give commands about what corrective measures should be taken. If user input is detected at step 409, respective corrective measures are taken according to step 409 and the method returns to displaying the representations of remaining artifacts according to step 408. When no user input is detected at step 409 (or some other user input is detected than such that would have caused a transition to step 410), the method ends.

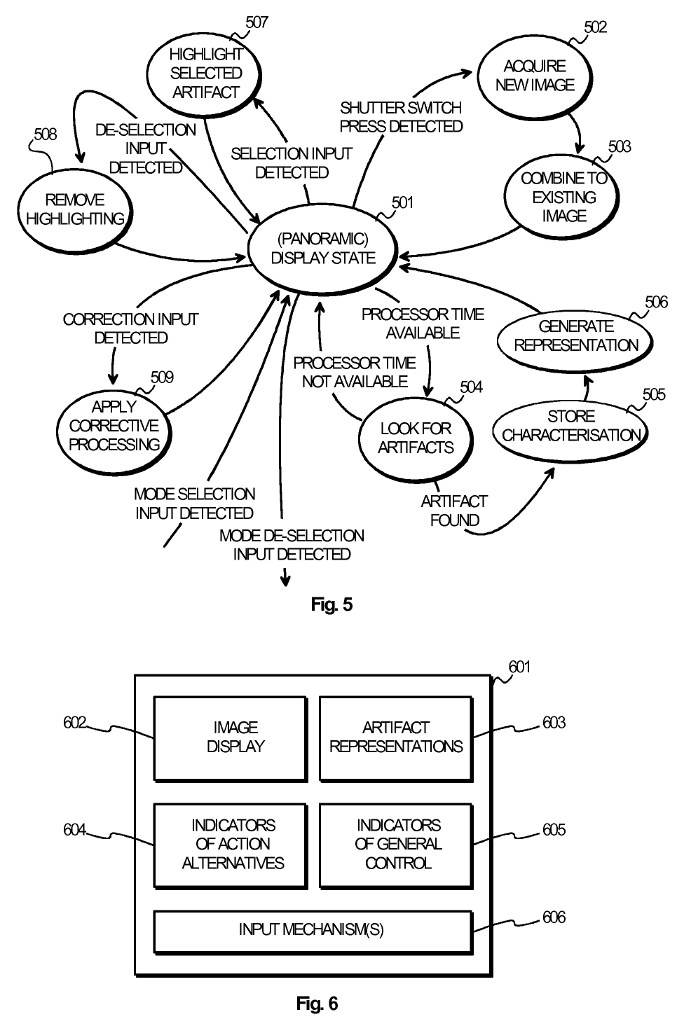

FIG. 5 illustrates an operating principle of a method and a computer program product according to one embodiment of the invention, where linear proceeding through sequential steps is not emphasized, but execution proceeds as transitions between states triggered by the fulfilment of predefined transition conditions. A panoramic display state 501 is a basic state at which the execution resides unless one of those predefined transition conditions is fulfilled that cause a transition to another state. The panoramic display state 501 was entered when the apparatus received from the user a command for entering panoramic imaging mode. The state diagram of FIG. 5 is easily applied in single-image mode by neglecting the word panoramic.

Assuming that the method and computer program product are executed in an electronic image acquisition device, there is a shutter switch or some other control, the activation of which causes the device to enter an image acquisition state 502, where a new image is acquired. We assume that the current operating mode involves automatic adding of new images to the currently displayed panoramic image, so from said image acquisition state 502 an immediate transition occurs to a stitching state 503, in which the newly acquired image is stitched to the panoramic image that is currently displayed. After that the execution returns to the panoramic display state 501.

If the method and computer program product are executed in an apparatus that is not an electronic image acquisition device, it may happen that there is no shutter switch and no direct means of creating new images by the apparatus itself. In that case there may be a new image acquisition process that otherwise resembles that illustrated as the loop through states 502 and 503 in FIG. 5 but that involves receiving the digitally stored form of an image into run-time memory over a communications connection, or reading into run-time memory the digitally stored form of an image from a storage memory that can be internal, external and/or removable.

We assume that the method and computer program product are executed in an apparatus that comprises a processor. In the embodiment of FIG. 5, available processor time is utilized by making the processor execute at least one algorithm for locating artifacts in the panoramic image that is currently displayed. Looking for artifacts is illustrated as state 504. In the embodiment of FIG. 5 looking for artifacts is a background process in the sense that if a need occurs for making the processor execute something else, i.e. processor time is temporarily not available for finding artifacts, a return to the panoramic display state 501 occurs. If, while the execution is in the state 504 of looking for artifacts, an artifact is found, its characterisation is stored according to state 505, a representation of the artifact is generated according to state 506 for representing it in the user interface, and a return to the panoramic display state 501 occurs in order to update the displayed image with the representation of the newly found artifact.

A natural alternative to making the processor look for artifacts as a background process is to implement the looking for artifacts as a dedicated process, which is commenced as response to a particular input received from the user and ended either when all applicable parts of the image have been searched through or when an ending command is received.

A specific case of locating an artifact in state 504 is the case of receiving an input from the user, indicating an explicit marking of some part of the image as containing an artifact. In terms of FIG. 5 it causes a similar transition to state 505, but as a part of storing the characterisation of the artifact, there is stored an indicator that it is an artifact pointed out by the user.

The panoramic display state 501 of FIG. 5 comprises keeping current representations of found artifacts available to the user for selection. As an example, graphical effects can be used in a displayed panoramic image to highlight part(s) of the panoramic image that contain artifacts, and/or representations of found artifacts may be listed on a displayed list that contains alphanumeric and/or graphical description of the listed artifacts. We assume that the apparatus comprises one or more selection controls, through which the user may browse through the available representations of artifacts. When a selection input is detected, a transition occurs to a state 507 of highlighting the selected artifact, so that the apparatus provides the user with visual feedback about an active selection. An immediate return to state 501 is illustrated in FIG. 5, but this means that the selection remains active and highlighted. Only if a de-selection input is thereafter detected (which can be an active input from the user or the absence of any active input from the user within a predefined time), the highlighting of the selection is removed in state 508 before returning again to state 501.

More than one representation of artifact can be selected and highlighted simultaneously. In FIG. 5 this would correspond to circulating two or more times through the highlighting state 507. The highlighted set of representations may be said to represent a selected subset of artifacts.

After a loop through state 507 the representation of at least one artifact is highlighted in the user interface. The term “highlighted” may mean that in addition to providing the user with visual feedback about the selection of the artifact itself, the apparatus may be configured to offer the user some suggested possibilities of corrective action. Examples include, but are not limited to, displaying action alternatives associated with softkeys or actuatable icons, like “corrective processing”, “take new image”, and the like. If at such moment the apparatus detects an input from the user that means the selection of corrective processing, the execution enters state 509 in which corrective processing is performed, followed by a return to state 501. As an alternative, if at said moment the apparatus detects a new press of the shutter switch or other signal of acquiring a new image, a new loop through the image acquisition and stitching states 502 and 503 occurs.

Re-entering state 501 after e.g. state 509 or 503 may mean that—while processor time is available—the apparatus is configured to run a check at state 504 to see whether the corrective action was sufficient to remove at least one artifact. If that is the case, returning from state 504 through states 505 and 506 to state 501 may mean that the user does not observe any representation for the corrected artifact any more. If some other artifacts remain, the user may direct the apparatus to select each of them in turn and apply the selected corrective action through repeated actions like those described above. If the user decides to accept a panoramic image displayed in state 501, he may issue a mode de-selection command to exit panoramic imaging mode, or begin acquiring component images for a completely new panoramic image. Depending on how the user interface has been implemented, the latter alternative may involve receiving, at the image acquisition apparatus, an explicit command from the user, or e.g. just acquiring a new component image that does not overlap with any of the component images that constituted the previous panoramic image.

There are various ways of utilizing new image data that has been acquired as a response to receiving from a user a corresponding command. Examples of such ways include, but are not limited to, blending the new image data to the image data of the processed images, creating a tunnel of data to the processed image (i.e. enabling a ‘close-up’ inside an image, that is, with higher resolution than the rest of the image), and simply detaching or attaching data to the processed image.

FIG. 6 is a schematic illustration of an exemplary user interface 601 according to an embodiment of the invention. The user interface 601 comprises an image display, or image displaying means, 602 for displaying images, particularly for displaying a panoramic image that is the result of stitching image data from at least two component images. The user interface 601 comprises also an artifact representations output, or means for outputting artifact representations, 603 for giving the user indications about artifacts found in a displayed image. Most advantageously the artifact representations output has some other form than just allowing the artifacts show as such in a displayed image, because an apparatus the user interface of which is in question may be a small-sized portable apparatus, which may have a relatively small display available for displaying images. Artifacts may be difficult to notice if they only appear as such in the image displayed on the small display of a portable apparatus, without any specifically provided enhancement or separate representation.

The user interface 601 comprises also action alternative indicators, or means for indicating action alternatives, 604. These may be audible, visual, tactile, or other kinds of outputs to the user for making the user conscious about what action alternatives are available for responding to the occurrence and indication of known artifact(s) in the displayed image. The user interface 601 comprises also general control indicators, or means for indicating general control alternatives, 605. These may be audible, visual, tactile, or other kinds of outputs to the user for making the user conscious about what general control functionalities, like exiting a current state or moving a selection, are available.

Additionally the user interface 601 comprises input mechanisms, or user input means, 606. These may include, and be any combination of, key(s), touchscreen(s), mouse, joystick(s), navigation key(s), roller ball(s), voice control, or other types of input mechanisms.

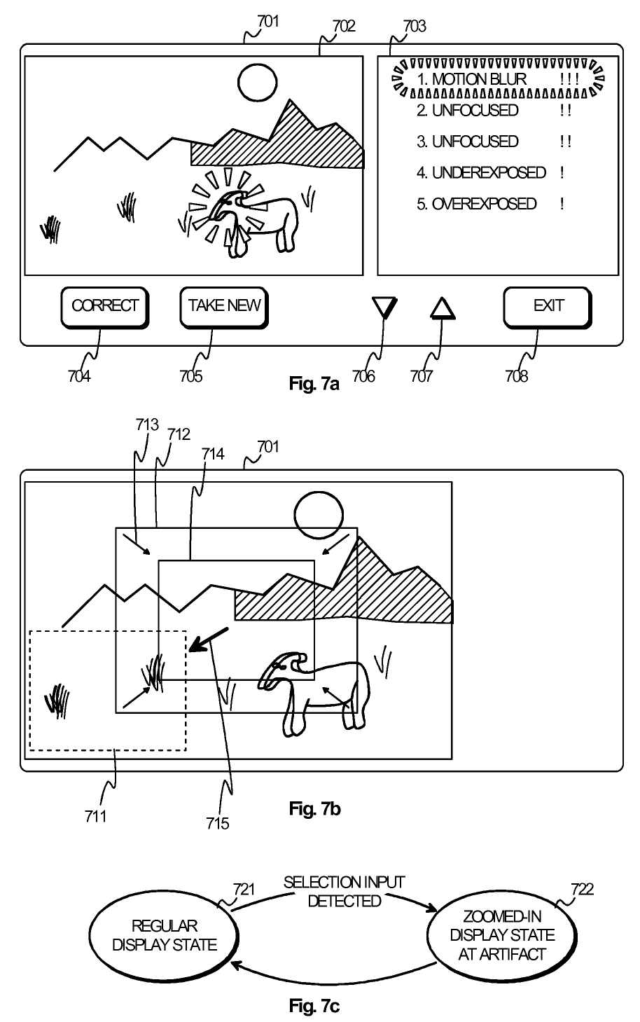

FIG. 7a illustrates a part of a user interface according to an embodiment of the invention. The user interface comprises a display 701, which comprises an image display area 702, an information display area 703, and indicators of input alternatives 704, 705, 706, 707, and 708. It is not necessary to divide the area of the display into separate areas for displaying e.g. the image and information; it is likewise possible to use overlaid displaying practices so that e.g. informative graphical elements are displayed on top of a displayed image. Even the elements of a displayed image itself may be given informative functions, for example by making some feature(s) of the image appear in a distinct, artificial colour and/or by making some feature(s) of the image blink or exhibit other kinds of dynamic behaviour.

According to an exemplary embodiment of the invention, the display 701 may be a touch-sensitive display, and the indicators of input alternatives 704, 705, 706, 707, and 708 may be touch keys implemented as predefined areas of the touch-sensitive display. According to another exemplary embodiment, the indicators of input alternatives 704, 705, 706, 707, and 708 may be visual indicators associated with softkeys (not shown), so that the user is given guidance concerning how the apparatus will respond to pressing a particular softkey. According to yet another exemplary embodiment the apparatus may comprise a mouse, a joystick, a navigation key, a roller ball, or some corresponding control device (not shown) with immediate graphical feedback on display, so that the indicators of input alternatives 704, 705, 706, 707, and 708 could be clickable icons. Alternative embodiments of indicators are mutually combinable, so that different techniques can be used for different indicators.

The indicators of input alternatives are in this exemplary embodiment the following:
Correction input indicator 704 for indicating the input alternative of making the apparatus begin corrective processing.
New image acquisition indicator 705 for indicating the input alternative of making the apparatus acquire a new image. It is neither necessary nor precluded to make the indicator itself operate as the shutter switch.

According to one alternative, the indicator is only displayed on the display to remind the user that one possible way of correcting a particular artifact is to take a new image, but in order to actually take a new image the user must press a separate shutter switch.
Selection arrow indicators 706 and 707 for controlling, which one of the listed artifact representations is selected and highlighted.
Exit indicator 708 for indicating the input alternative of exiting the current state.

Comparing the illustrated state of the user interface of FIG. 7a to the state transition diagram of FIG. 5, an exemplary assumption is that the execution has proceeded three times through the loop comprising states 502 and 503, so that three component images have been acquired and stitched. Additionally the execution has proceeded five times through the loop comprising states 504, 505, and 506, so that five artifacts have been found, their characterisations have been stored, and their representations have been generated. The visible representation of each found artifact is one alphanumeric line in the information display area 703. The topmost representation is highlighted in FIG. 7a, and additionally the apparatus is configured to display a corresponding highlighting in the image display area 702 to show where the artifact is in the displayed image. Whether or not the execution has proceeded once through state 507 to highlight a selected artifact is not important, because the apparatus may have been configured to automatically highlight the first artifact without needing a particular selection command from the user.

In this exemplary embodiment we assume that the apparatus is configured to evaluate the severity of each found artifact on a three-tier scale, to store the result of the evaluation as a part of the characterisation of the artifact, and to indicate the stored result of the evaluation with one, two, or three exclamation marks in the representation of the artifact. Additionally we assume that the apparatus is configured to automatically organise the displayed list of artifact representations so that the representations of artifacts for which severity was evaluated to be high are displayed first in said list.

It is also useful to zoom into the artefact area so the user can better visually evaluate whether the artefact is something that should be addressed, or whether the user is happy with the current result, and the artefact detection was in fact a false alarm. The zooming level should be calculated to be sufficient so that the user can clearly see the problem, in most cases the system should be able to automatically calculate the correct level. If the system keeps track of which artifacts at which severity level the user finds objectionable, the system can train its threshold levels so that in the future there will be fewer false alarms.

Which indicators are displayed may depend on which kind of artifact is currently highlighted. The apparatus may have been configured to only offer a particular subset of corrective action alternatives, depending on whether it is assumed to be possible to correct the selected artifact with any of the available alternatives for corrective action. For example, it is hardly plausible to attempt correcting a large area of missing picture content through any other corrective action than taking a new image, while it is may be possible to correct a small area of unfocused image content with filtering or other suitable processing. One of the displayed alternatives may be “no action” or “leave as is” or other indication of no action at all, to prepare for cases in which an algorithm for locating artifacts believes something to be an artifact, while it actually is an intended visual element of the (possibly panoramic) image.

In the exemplary case of FIG. 7a, if user input is detected and associated with any of the selection arrow indicators 706 or 707, the apparatus is configured to move the selection, i.e. de-select the previously selected artifact representation, remove its highlighting, and select and highlight the next adjacent artifact representation on the displayed list. If user input is detected and associated with the correction input indicator 704, the apparatus is configured to commence an image processing algorithm targeted to selectively change pixel values within the affected area to correct the artifact. If user input is detected and associated with the new image acquisition indicator 705, the apparatus is configured to either acquire a new image immediately or to make itself ready for acquiring a new image as a response to a subsequent actuation of a shutter switch.

FIG. 7b illustrates another aspect of user interface interactivity. We may assume that a representation of such an artifact has been displayed, the correction of which is most advantageously done by acquiring a new component image. A certain part of the displayed image has been considered as problematic, i.e., as containing the artifact. This part is illustrated in the display with a frame 711 overlaid with the displayed image. According to the aspect illustrated in FIG. 7b, the apparatus is configured to give the user instructions about how to take the new component image, so that it would optimally cover a part of the original image where an artifact should be corrected.

An example of such instructions is illustrated in FIG. 7b. The current zoom state and pointing of the electronic image capturing device are illustrated in the display with another frame 712 overlaid with the displayed image; in other words, if the user now pressed the shutter switch, a new component image would be taken of what is currently seen within frame 712. In order to guide the user to take the new component image of the appropriate part of the scene, instructions are given in graphical form on the display. Examples of such instructions in FIG. 7b are the zoom-in arrows 713 and zoom target frame 714, which instruct the user to zoom in enough to make the focal length match that needed for taking the required new component image. Another example of instructions is the move arrow 715, which instructs the user to turn the pointing direction of the electronic image capturing device so that it would point to the appropriate direction for taking the new component image.

A number of different mechanisms can be utilized to make the electronic image capturing device aware of what kinds of instructions it should give to the user. For example, the image currently provided by the viewfinder functionality (i.e. the electronic representation of an image that is dynamically read from the image sensor) can be compared with the image data of the displayed (possibly panoramic) image to find a match, at which location the current-view frame (illustrated in FIG. 7b as frame 712) should be overlaid with the displayed image. If the electronic image capturing device includes motion detectors, their stored output signals may be used to derive the current pointing direction of the device in relation to what it was when the original (component) image(s) was taken. Such directional information can be used to augment or replace directional information based on image content matching in determining the directions to be given to the user.

Irrespective of which mechanisms are used to instruct the user to prepare for taking a new image, a feedback signal could be given to the user when the apparatus concludes that the user has followed the instructions within an acceptable tolerance, so that the new image can be taken. Such feedback may comprise, e.g., flashing the correctly aligned instructive frames on display, outputting an audible signal, or even automatically acquiring the new image without requiring the user to separately actuate any shutter switch.

The most optimal settings (exposure, aperture, white balance, focus, etc.) that should be used in taking the new component image are possibly not the same as those that were used to take the original (component) image(s). As a part of giving instructions to the user about taking the new component image, instructions may be given about how to make the most appropriate settings. Such instructions could appear as displayed prompts, other visual signals, synthesized speech signals, or other. As an alternative, the apparatus could prepare certain settings for use automatically, and take them into use as a response to observing that the user has followed certain instructions, e.g. pointed and zoomed the electronic image acquisition device according to the suggested frame for the new component image.

FIG. 7c illustrates a feature that can be utilized to make it easier for a human user to make a judgment about a selected artifact. In a so-called regular displaying state 721, which may be for example the state illustrated as 501 in FIG. 5 and that may correspond to what is illustrated in FIG. 7a without highlighting, representations of artifacts are displayed or otherwise brought to the attention of the user. When a selection input is received from the user, there occurs a change to state 722, in which an enlarged view is displayed of a part of the previously displayed image that contains the selected artifact. A return to the regular displaying state may be triggered by various events, for example receiving from the user a “return” input, or observing the expiration of a timeout, or receiving from the user an input that already constitutes the selection of corrective processing referred to above in FIG. 5.

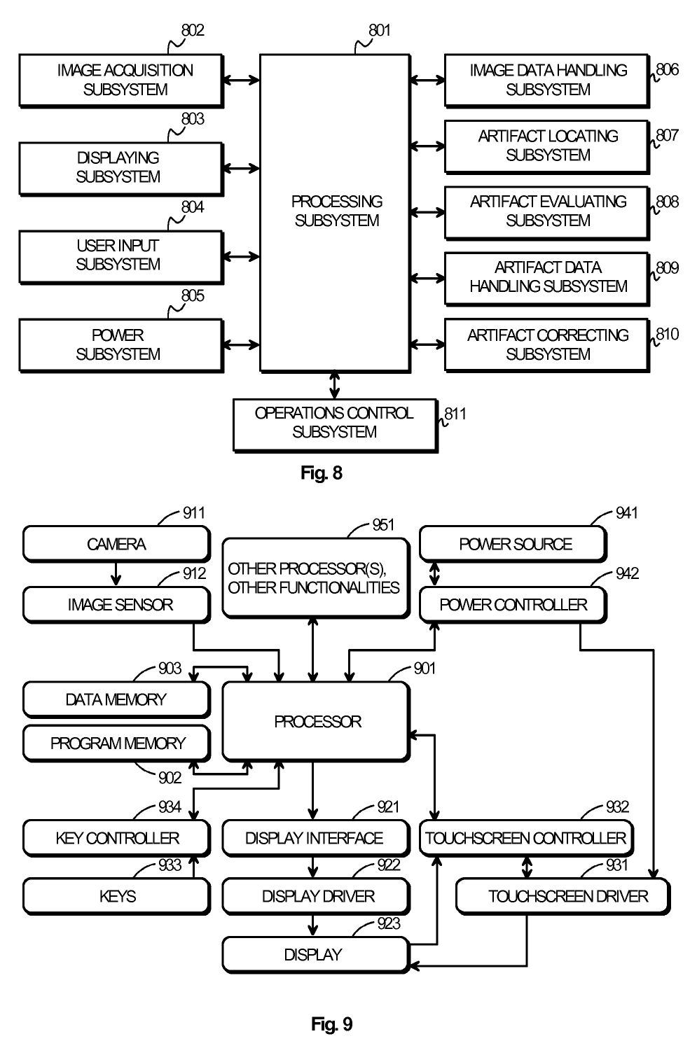

FIG. 8 is a schematic system-level representation of an exemplary apparatus according to an embodiment of the invention. A processing subsystem 801 is configured to perform digital data processing involved in executing methods and computer program products according to embodiments of the invention. An image acquisition subsystem 802 is configured to acquire image data for processing under the control of the processing subsystem 801. A displaying subsystem 803 is configured to display and possibly otherwise output to user graphical and other information concerning the operations of the system, as controlled by the processing subsystem 801. A user input subsystem 804 is provided for allowing users to give inputs to and otherwise affect the operation of the processing subsystem 801. A power subsystem 805 is configured to store and distribute operating power to all other parts of the system.

Subsystems on the right in FIG. 8 preferably constitute together a computer program product, meaning that they comprise machine-readable software instructions stored on a machine-readable medium, so that when at least a part of these software instructions are executed in the processing subsystem 801, they cause the implementation of the actions that have been described as parts of methods according to embodiments of the invention. An image data handling subsystem 806 is configured to, and comprises means for, reading in, storing, copying, organising and otherwise processing image data. Stitching algorithms, if present, may constitute a part of the image data handling subsystem 806. An artifact locating subsystem 807 is configured to, and comprises means for, locating artifacts from groups of stored pixel values that together constitute the electronic representation of an image, which may be a stitched panoramic image. An artifact evaluating subsystem 808 is configured to, and comprises means for, evaluating a found artifact in terms that comprise at least some of location, severity, and susceptibility to various possibly available corrective measures. An artifact data handling subsystem 809 is configured to, and comprises means for, handling data that results from the operation of the artifact locating and evaluating subsystems 807 and 808 respectively. Algorithms for storing characterisations of the located artifacts, and for generating and outputting representations of found and evaluated artifacts, constitute a part of the artifact data handling subsystem 809. An artifact correcting subsystem 810 is configured to, and comprises means for, processing groups of pixel values so that artifacts contained therein are removed and/or their visible effect in a displayed image is decreased.

According to an embodiment of the invention, the task of correcting located artifacts can be dedicated solely to acquiring new images and stitching them into a panoramic image (if one exists), instead of attempting any kind of corrective processing of the previously existing image data. In such cases the artifact correcting subsystem 810 is actually accommodated in the image acquisition subsystem 802 and the image data handling subsystem 806.

The apparatus of FIG. 8 comprises also an operations control subsystem 811, which is configured to, and comprises means for, controlling the general operation of the apparatus, including but not being limited to implementing changes of operating mode according to inputs from the user, organising work between the different subsystems, distributing processor time, and allocating memory usage.

FIG. 9 illustrates a block diagram of an exemplary apparatus according to an embodiment of the invention. A processing subsystem in said apparatus comprises a processor 901, a program memory 902 configured to store the programs to be executed by the processor 901, as well as a data memory 903 configured to be available for the processor 901 for storing and retrieving data. The memories 902 and 903 may comprise any of internal and external memory circuits of the processor and their combinations, and they or parts of them may be located on removable and/or portable memory means. The processor 901 may be for example an ARM processor (Advanced RISC Machine; where RISC comes from Reduced Instruction Set Computing).

An image acquisition subsystem in the apparatus of FIG. 9 comprises a camera 911 and an image sensor 912, coupled to the processor 901 so that the processor 901 is configured to read electronic representations of acquired images from the image sensor 912. Together the camera 911 and image sensor 912 can be said to constitute a digital camera. A displaying subsystem in the apparatus of FIG. 9 comprises a display interface 921 configured to communicate with the processor 901 concerning information to be displayed, a display driver 922 configured to receive the data for display from the display interface 921, and a display element 923 configured to be driven by the display driver 922. In this particular embodiment the display element 923 comprises the features of a touchscreen (included in block 923), and the user input subsystem of the apparatus comprises a touchscreen driver 931 configured to drive the touchscreen, as well as a touchscreen controller 932 coupled between the processor 901 and the touchscreen and configured to both control the operation of the touchscreen through the touchscreen driver 931 and convey input information obtained through the touchscreen to the processor 901.

The user input subsystem in the apparatus of FIG. 9 may comprise one or more keys 933 and a key controller 934 configured to detect actuation of keys and to convey input information obtained through the keys to the processor 901. Various implementations of the user input subsystem can be used as alternatives to each other or to complement each other. A power subsystem in the apparatus of FIG. 9 comprises a power source 941 and a power controller 942 coupled between the power source 941 and the other power-requiring elements of the apparatus. For reasons of graphical clarity, only the couplings from the power controller 942 to the processor 901 and the touchscreen driver 931 are shown.

The subsystems of FIG. 8 that were explained as most advantageously being implemented in a computer program product would most naturally reside in stored form in the program memory 902 of FIG. 9, keeping in mind that the simple representation of one memory block in the drawing covers a large number of possible practical implementations with internal, external, removable and/or portable memory means used in various configurations.

The apparatus may comprise another processor or processors, and other functionalities than those illustrated in the exemplary embodiment of FIG. 9. As an example we may consider an apparatus that has the capability of operating as a mobile station in a wireless communication system. In an exemplary configuration of that kind, the block illustrated as the other processor(s) and functionalities block 951 coupled to the processor 901 could comprise a digital baseband processor and further couplings to wireless transceiver circuitry and one or more antennas.

The apparatus of FIG. 9, as well as apparatuses according to other embodiments of the invention, could be built with a modular structure. According to an embodiment of the invention a module comprises a processor with an image data input configured for receiving image data. The processor is configured to, and comprises means for, storing an electronic representation of an image, outputting the image and representations of artifacts located in said image for display, and receiving user inputs concerning corrective action to be taken to correct artifacts, representations of which were displayed.

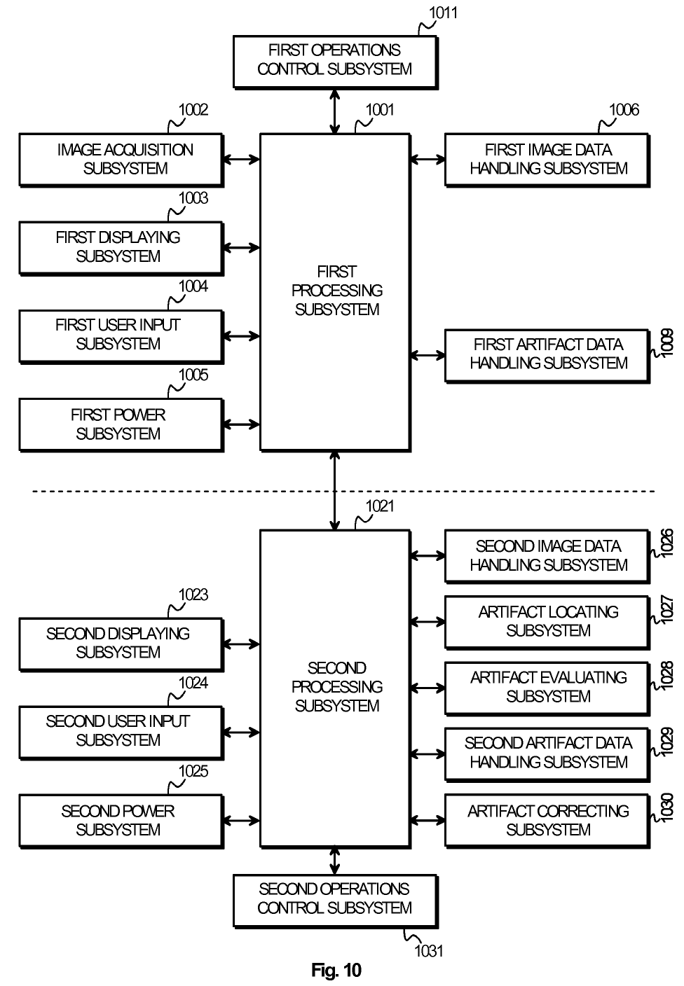

FIG. 10 illustrates an arrangement where a first apparatus (upper half of the drawing) is configured to acquire and store images, and a second apparatus is configured to receive acquired image data from the first apparatus and to process the image data for locating, characterising and removing artifacts from images, which may be panoramic images stitched from the acquired image data. The first apparatus comprises a first processing subsystem 1001 configured to perform digital data processing involved in executing the methods and computer program products that are needed for the acquisition and handling of image data from an image acquisition subsystem 1002. Additionally the first processing subsystem 1001 configured to perform digital data processing involved in executing the methods and computer program products that are needed for exchanging acquired image data and processed image data with the second apparatus. Said computer program products are preferably stored as parts of a first operations control subsystem 1011, a first image data handling subsystem 1006, and potentially also a first artifact data handling subsystem 1009.

In order to offer a user the possibility of operating the first apparatus, it comprises a first displaying subsystem 1003 and a first user input subsystem 1004, both coupled to the first processing subsystem 1001. A first power subsystem 1005 is configured to provide the first apparatus with operating power.

The second apparatus comprises a second processing subsystem 1021 configured to perform digital data processing involved in executing methods and computer program products according to embodiments of the invention. Coupled to the second processing subsystem 1021 are a second image data handling subsystem 1026, an artifact locating subsystem 1027, an artifact evaluating subsystem 1028, an artifact data handling subsystem 1029, and an artifact correcting subsystem 1030. These resemble the correspondingly named subsystems in the apparatus of FIG. 8, in the sense that the subsystems 1026-1030 are configured to, and comprise means for, performing in a similar way that was described above in association with subsystems 806-810 of FIG. 10 respectively.

A second power subsystem 1025 is configured to provide the second apparatus with operating power. A second operations control subsystem 1031 is configured to, and comprises means for, controlling the general operation of the second apparatus, including but not being limited to implementing changes of operating mode according to inputs from user(s), organising work between the different subsystems, distributing processor time, and allocating memory usage. A second displaying subsystem 1023 and a second user input subsystem 1024 may be provided and coupled to the second processing subsystem, but these are not necessary, at least not in all embodiments with two apparatuses like in FIG. 10.

The arrangement of FIG. 10 can be used to implement interactively corrective image processing in various different ways. A first of these is an embodiment of the invention where a user utilizes the first apparatus for image data acquisition and the second apparatus for processing images, having both apparatuses in his direct control. As an example, the first apparatus could be a portable electronic image capturing device and the second apparatus could be a computer, like a palmtop, laptop, or tabletop computer. Both of said devices should be suitably equipped for local connectivity, for example through a wired connection, short-distance wireless connection, indirect connection through removable memory, or other.

A second way is an embodiment of the invention where a user utilizes the first apparatus for image data acquisition, sends image data over to the second apparatus for panoramic image processing and/or locating artifacts, and receives completed panoramic images and/or other feedback to the first apparatus. As an example, the first apparatus can be a portable electronic device equipped with both a digital camera and a communications part, and the second apparatus can be a server that is coupled to a network and used to offer image processing services to users over the network.

Assuming the last-mentioned purpose and configuration of the first and second apparatuses, an example of processing panoramic image data goes as follows. The user of the first apparatus acquires a number of component images with subsystem 1002 and sends them over to the second apparatus, with the image data handling operations being performed by the first image data handling subsystem 1006. The second apparatus receives the component images, stitches them into a panoramic image in subsystem 1026, and processes the panoramic image for locating and evaluating artifacts in subsystems 1027 and 1028 respectively. Characterisations of artifacts handled by subsystem 1029 are sent back to the first apparatus, together with the stitched panoramic image and possible other information that the user may use in deciding, whether the panoramic image should be improved and in which way. The first apparatus handles the characterisations and/or representations of artifacts in subsystem 1009, displays the panoramic image and representations of artifacts on subsystem 1003, and receives inputs from the user through subsystem 1004 concerning the required corrective action. Information associated with such corrective action that can be implemented through processing is transmitted to the second apparatus, which performs the corrective processing in subsystem 1030 and transmits the corrected panoramic image (or, if only a part of the panoramic image needed to be corrected, the corrected part of the panoramic image) back to the first apparatus. Depending on where the final form of the panoramic image is to be stored, the first apparatus may respond to corresponding user input by storing the corrected panoramic image locally and/or by transmitting to the second apparatus a request for storing the corrected panoramic image at the second apparatus or somewhere else in the network.

A third way is a variation of that described immediately above, with the difference that the first image data handling subsystem 1006 in the first apparatus is configured to stitch component images into an output compound image, so that what gets transmitted to the second apparatus is not component images but a single stitched output image. Here we may consider a continuum, starting from a single untouched image, a single image where some parts of an image has been changed, to a panoramic image that extends the field of view to be larger than what can be obtained in a single view, so that the first apparatus may transmit even a single image to the second apparatus. This embodiment of the invention saves transmission bandwidth, because the second apparatus only needs to transmit back the characterisations of artifacts; at that stage both apparatuses already both possess that form of the (possibly panoramic) image for which these characterisations are pertinent. Representations of the artifacts may be generated in subsystem 1009 and shown to the user on subsystem 1003, and corrective action may be implemented in the first apparatus, by acquiring one or more additional images and/or by applying corrective processing. The first apparatus may produce a corrected (possibly panoramic) image after such corrective action. It is optional, whether the corrected image should be once more transmitted to the second apparatus for another round of locating artifacts and returning artifact data.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

We claim:

1. An apparatus, comprising:
an artifact locating subsystem configured to locate an artifact in an electronic representation of an image,
an artifact evaluating subsystem configured to store a characterisation of a located artifact, and
an artifact data handling subsystem configured to output at least one of a characterisation of an artifact or a representation of a stored characterisation of an artifact.

2. An apparatus according to claim 1, comprising an artifact correcting subsystem configured to respond to an input by implementing corrective measures for correcting an artifact that was located and a characterisation of which was stored.

3. An apparatus according to claim 2, wherein said artifact correcting subsystem is configured to respond to an input by processing existing image data of said image.

4. An apparatus according to claim 2, wherein said artifact correcting subsystem is configured to respond to an input by acquiring new image data and combining the acquired new image data with said electronic representation of the image in which the artifact was located.

5. An apparatus according to claim 1, comprising an image data handling subsystem configured to stitch at least partially overlapping component images into a panoramic image, and to output an electronic representation of said panoramic image as an input to the artifact locating subsystem.

6. An apparatus according to claim 1, comprising an image acquisition subsystem configured to convert a two-dimensional distribution of electromagnetic radiation intensity at various wavelengths into an electronic representation of an image.

7. An apparatus according to claim 6, wherein the image acquisition subsystem comprises a digital camera.

8. An apparatus according to claim 1, comprising a displaying subsystem configured to display a representation of an artifact.

9. An apparatus according to claim 8, wherein the apparatus is configured to display an image along with a representation of an artifact located in said image.

10. An apparatus according to claim 9, wherein the apparatus is configured to display an ordered list of representations of artifacts located in said image.

11. An apparatus according to claim 9, wherein the apparatus is configured to display the representation of a selected artifact in a highlighted form.

12. An apparatus according to claim 9, wherein the apparatus is configured to display indicators of input alternatives, which comprise at least one of the following: input alternative of making the apparatus begin corrective processing, input alternative of making the apparatus acquire a new image.

13. An apparatus according to claim 12, wherein the apparatus is configured to choose at least one indicator of input alternative for display, together with a highlighted representation of an artifact, on the basis of what corrective action is applicable for correcting the artifact the representation of which is highlighted.

14. An apparatus according to claim 9, wherein the apparatus is configured to respond to an input that indicates selection of one displayed representation of an artifact by displaying a zoomed-in view of that artifact in the displayed image.

15. An apparatus according to claim 9, wherein the apparatus is configured to display a prompt for acquiring a new image along with instructions about how the new image should be acquired.

16. An apparatus according to claim 1, wherein the artifact locating subsystem is configured to determine that a piece of image data contains an artifact, if through filtering operation said piece of image data comprises at least one positive feedback from a set of predefined filters that are designed to detect various types of artefacts.

17. An apparatus according to claim 1, wherein the artifact evaluating subsystem is configured to store information of at least one of the following as a part of the characterisation of an artifact: location of the artifact in the image, type of the artifact, severity of the artifact.

18. An apparatus according to claim 1, comprising wireless transceiver circuitry and one or more antennas for implementing communications in a wireless communications system.

19. An apparatus according to claim 1, comprising a network connection, wherein the apparatus is configured to receive electronic representations of images through the network connection and to transmit characterisations of located artifacts through the network connection.

20. An apparatus, comprising:
an image data handling subsystem configured to store electronic representations of images,
an artifact data handling subsystem configured to handle characterisations of artifacts located in an image,
a displaying subsystem configured to display an image and representations of artifacts located in said image, and
a user input subsystem configured to receive user inputs concerning corrective action to be taken to correct artifacts, representations of which were displayed in said displaying subsystem.

21. An apparatus according to claim 20, wherein the image data handling subsystem is configured to output the electronic representation of an image for transmission over a communications connection to an external apparatus, and wherein the artifact data handling subsystem is configured to store characterisations of artifacts received over a communications connection from the external apparatus.

22. An apparatus according to claim 21, comprising wireless transceiver circuitry coupled to the image data handling subsystem and the artifact data handling subsystem, for operating as a mobile station in a wireless communications system.

23. An apparatus according to claim 21, wherein the apparatus is configured to respond to received user input by transmitting, to the external apparatus, information associated with such corrective action indicated by received user input that is applicable for implementation through processing in the external apparatus.

24. An apparatus according to claim 20, wherein the apparatus is configured to respond to received user input by implementing corrective action to correct artifacts in the image.

25. A method, comprising:
locating an artifact in an electronic representation of an image,
storing a characterisation of the located artifact, and
outputting at least one of a characterisation of the artifact or a representation of the artifact.

26. A method according to claim 25, comprising:
responding to an input by implementing corrective measures for correcting an artifact that was located and a characterisation of which was stored.

27. A method according to claim 26, wherein said measures for correcting an artifact comprise processing existing image data of said image.

28. A method according to claim 26, wherein said measures for correcting an artifact comprise acquiring new image data and combining the acquired new image data with said electronic representation of the image in which the artifact was located.

29. A method according to claim 25, comprising stitching at least partially overlapping component images into a panoramic image, and outputting an electronic representation of said panoramic image as an input to the step of locating an artifact.

30. A method according to claim 25, comprising acquiring an image by converting a two-dimensional distribution of electromagnetic radiation intensity at various wavelengths into an electronic representation of an image.

31. A method according to claim 25, comprising displaying a representation of an artifact.

32. A method according to claim 31, comprising displaying an image along with a representation of an artifact located in said image.

33. A method according to claim 32, comprising displaying an ordered list of representations of artifacts located in said image.

34. A method according to claim 31, comprising displaying the representation of a selected artifact in a highlighted form.

35. A method according to claim 31, comprising displaying indicators of input alternatives, which comprise at least one of the following: input alternative of making the apparatus begin corrective processing, input alternative of making the apparatus acquire a new image.

36. A method according to claim 35, comprising choosing at least one indicator of input alternative for display, together with a highlighted representation of an artifact, on the basis of what corrective action is applicable for correcting the artifact the representation of which is highlighted.

37. A method according to claim 32, comprising responding to an input that indicates selection of one displayed representation of an artifact by displaying a zoomed-in view of that artifact in the displayed image.

38. A method according to claim 32, wherein the apparatus is configured to display a prompt for acquiring a new image along with instructions about how the new image should be acquired.

39. A method according to claim 25, wherein locating an artifact comprises determine that a piece of image data contains an artifact, if through filtering operation said piece of image data comprises at least one positive feedback from a set of predefined filters that are designed to detect various types of artefacts.

40. A method according to claim 25, wherein storing a characterisation of the located artifact comprises storing information of at least one of the following: location of the artifact in the image, type of the artifact, severity of the artifact.

41. A method according to claim 25, comprising:
before said locating of an artifact, receiving the electronic representation of an image through a network connection, and
transmitting the output characterisation or representation of the artifact through the network connection.

42. A method according to claim 41, comprising:
receiving the electronic representations of at least two images through the network connection,
stitching the electronic representations of said at least two images into a panoramic image, and
locating the artifact in the electronic representation of the panoramic image.

43. A method, comprising:
storing an electronic representation of an image,
displaying the image and representations of artifacts located in said image, and
receiving user inputs concerning corrective action to be taken to correct artifacts, representations of which were displayed.

44. A method according to claim 43, comprising:
transmitting the electronic representation of the image over a communications connection to an external apparatus, and
storing characterisations of artifacts received over a communications connection from the external apparatus.

45. A method according to claim 44, comprising:
transmitting to the external apparatus information associated with such corrective action indicated by received user input that is applicable for implementation through processing in the external apparatus.

46. A method according to claim 43, comprising responding to received user input by implementing corrective action to correct artifacts in the image.

47. A computer-readable storage medium having computer-executable components that, when executed on a processor, are configured to implement a process comprising:
locating an artifact in an electronic representation of an image,
storing a characterisation of the located artifact, and
outputting at least one of a characterisation of the artifact or a representation of the artifact.

48. A computer-readable storage medium according to claim 44, having computer-executable components that, when executed on a processor, are configured to implement a process comprising:
responding to an input by implementing corrective measures for correcting an artifact that was located and a characterisation of which was stored.

49. A computer-readable storage medium according to claim 48, wherein said measures for correcting an artifact comprise processing existing image data of said image.

50. A computer-readable storage medium according to claim 48, wherein said measures for correcting an artifact comprise acquiring new image data and combining the acquired new image data with said electronic representation of the image in which the artifact was located.

51. A computer-readable storage medium according to claim 47, having computer-executable components that, when executed on a processor, are configured to implement a process comprising stitching at least partially overlapping component images into a panoramic image, and outputting an electronic representation of said panoramic image as an input to the step of locating an artifact.

52. A computer-readable storage medium according to claim 47, having computer-executable components that, when executed on a processor, are configured to implement a process comprising acquiring an image by converting a two-dimensional distribution of electromagnetic radiation intensity at various wavelengths into an electronic representation of an image.

53. A computer-readable storage medium according to claim 47, having computer-executable components that, when executed on a processor, are configured to implement a process comprising displaying a representation of an artifact.

54. A computer-readable storage medium according to claim 53, having computer-executable components that, when executed on a processor, are configured to implement a process comprising displaying an image along with a representation of an artifact located in said image.

55. A computer-readable storage medium according to claim 54, having computer-executable components that, when executed on a processor, are configured to implement a process comprising displaying an ordered list of representations of artifacts located in said image.

56. A computer-readable storage medium according to claim 53, having computer-executable components that, when executed on a processor, are configured to implement a process comprising displaying the representation of a selected artifact in a highlighted form.

57. A computer-readable storage medium according to claim 53, having computer-executable components that, when executed on a processor, are configured to implement a process comprising displaying indicators of input alternatives, which comprise at least one of the following: input alternative of making the apparatus begin corrective processing, input alternative of making the apparatus acquire a new image.

58. A computer-readable storage medium according to claim 57, having computer-executable components that, when executed on a processor, are configured to implement a process comprising choosing at least one indicator of input alternative for display, together with a highlighted representation of an artifact, on the basis of what corrective action is applicable for correcting the artifact the representation of which is highlighted.

59. A computer-readable storage medium according to claim 54, wherein the apparatus is configured to respond to an input that indicates selection of one displayed representation of an artifact by displaying a zoomed-in view of that artifact in the displayed image.

60. A computer-readable storage medium according to claim 54, wherein the apparatus is configured to display a prompt for acquiring a new image along with instructions about how the new image should be acquired.

61. A computer-readable storage medium according to claim 47, wherein locating an artifact comprises determine that a piece of image data contains an artifact, if through filtering operation said piece of image data comprises at least one positive feedback from a set of predefined filters that are designed to detect various types of artefacts.

62. A computer-readable storage medium according to claim 47, wherein storing a characterisation of the located artifact comprises storing information of at least one of the following: location of the artifact in the image, type of the artifact, severity of the artifact.

63. A computer-readable storage medium according to claim 47, having computer-executable components that, when executed on a processor, are configured to implement a process comprising:
before said locating of an artifact, receiving the electronic representation of an image through a network connection, and
transmitting the output characterisation or representation of the artifact through the network connection.

64. A computer-readable storage medium according to claim 63, having computer-executable components that, when executed on a processor, are configured to implement a process comprising:
receiving the electronic representations of at least two images through the network connection,
stitching the electronic representations of said at least two images into a panoramic image, and
locating the artifact in the electronic representation of the panoramic image.

65. A computer-readable storage medium, having computer-executable components that, when executed on a processor, are configured to implement a process comprising:
storing an electronic representation of an image,
displaying the image and representations of artifacts located in said image, and
receiving user inputs concerning corrective action to be taken to correct artifacts, representations of which were displayed.

66. A computer-readable storage medium according to claim 65, having computer-executable components that, when executed on a processor, are configured to implement a process comprising:
transmitting the electronic representation of the image over a communications connection to an external apparatus, and
storing characterisations of artifacts received over a communications connection from the external apparatus.

67. A computer-readable storage medium according to claim 66, having computer-executable components that, when executed on a processor, are configured to implement a process comprising:
transmitting to the external apparatus information associated with such corrective action indicated by received user input that is applicable for implementation through processing in the external apparatus.

68. A computer-readable storage medium according to claim 66, having computer-executable components that, when executed on a processor, are configured to implement a process comprising responding to received user input by implementing corrective action to correct artifacts in the image.
